(19) United States
(12) Patent Application Publication
(10) Pub. No.: US 2017/0054402 A1
(43) Pub. Date: Feb. 23, 2017

(54) DC CONSTANT-SPEED BRUSHLESS FAN MOTOR HAVING WIDE VOLTAGE INPUT

(71) Applicant: Tsung-Te Ho, Chiayi County (TW)

(72) Inventor: Tsung-Te Ho, Chiayi County (TW)

(21) Appl. No.: 14/829,714

(22) Filed: Aug. 19, 2015

(51) Int. Cl. H02P 27/08; F04D 19/00; F04D 27/00; F04D 25/06

(52) U.S. Cl. CPC H02P 27/08; F04D 25/0693; F04D 19/002; F04D 27/004

(57) ABSTRACT

A direct current (DC) constant-speed brushless fan motor having a wide voltage input, comprising a power supply unit; a fan motor driving unit, connected to the power supply unit; a fan motor, connected to the fan motor drive unit; a fan motor control unit, connected to the fan motor; and a sensing unit, connected to the fan motor control unit. As such, the power supply unit may be used to accept a wide voltage input and convert the wide input voltage into an appropriate output power, so that the appropriate output power may be outputted to the brushless fan motor through the fan motor control unit and the fan motor drive unit. As such, the fan motor may reach a target rotational speed which may not be changed with the input voltage, with the efficacies of saved consumed energy and elimination of operation noise achieved simultaneously.

### FIELD OF THE INVENTION

The present invention relates to a direct current (DC) constant-speed brushless fan motor, and particularly to a DC constant-speed brushless fan motor, where a power supply unit may be used to accept a wide input voltage and convert the wide input voltage into an appropriate output power, so that the appropriate output power may be outputted to the brushless fan motor through a fan motor control unit and a fan motor drive unit. As such, the fan motor may reach a target rotational speed which may not be changed with the input voltage, with the efficacies of saved consumed energy and elimination of operation noise achieved simultaneously.

### DESCRIPTION OF THE RELATED ART

In a currently available direct current (DC) fan motor, a fixed input voltage is connected and a fan motor drive unit, a fan motor control unit and a sensing unit are used to drive the fan motor to operate. In the case where the rotational speed is desired to changed, a modulation control unit is introduced to receive an external signal and then the fan motor control unit is relied upon to change the fan motor's rotational speed.

However, the above DC brushless fan motor may not accept a wide range variation of the input voltage in operation since the rotational speed may alter with the variation of the input voltage. In this case, a low voltage may not drive a high voltage motor and a high voltage may not drive a low voltage, imposing a restriction on the fan motor's operation. Furthermore, a motor's hot plugging action may not be performed when an external system is operated.

When the power supply is off, since a power protection used diode is reversely connected up in the fan motor, an electromotive force (EMF) energy of an inductor of the fan motor fails to be expelled. In response, the EMF energy is expected to be actively eliminated. A modulation unit is used to change the rotational speed by using a constant frequency PWM, in which an ON/OFF period is used to determine the rotational speed. When the ON/OFF period is employed to drive the fan motor, the fan motor may have a decreased efficiency. Assume two fan motors have the same power output, the one having the PWM of 100% has a less power consumption than the other of 50%, and the one having the PWM of 50% is further less than the other of 20%. In general, the fan motor is operated under a low to middle rotational speed and seldom a full rotational speed. Hence, the fan motor driven by the PWM ON/OFF period has a very low efficiency when it is operated under a low rotational speed.

To improve the above demerits, such particularly as the change dependency with the input voltage, the large power consumption, low efficiency issues, the inventor of the present invention sets forth a DC constant-speed brushless fan motor having a wide input voltage, so as to effectively improve the demerits encountered in the prior art.

### SUMMARY OF THE INVENTION

It is, therefore, an object of the present invention to provide a direct current (DC) constant-speed brushless fan motor, where a power supply unit may be used to supply a wide input voltage and convert the wide input voltage into an appropriate output power, so that the appropriate output power may be outputted to the brushless fan motor through a fan motor control unit and a fan motor drive unit. As such, the fan motor may reach a target rotational speed which may not be changed with the input voltage, with the efficacies of saved consumed energy and elimination of operation noise achieved simultaneously.

To achieve the above object, the DC constant-speed brushless fan motor having the wide input voltage according to the present invention comprises a power supply unit; a fan motor driving unit, connected to the power supply unit; a fan motor, connected to the fan motor drive unit; a fan motor control unit, connected to the fan motor; and a sensing unit, connected to the fan motor control unit.

In an embodiment, the power supply unit, the fan motor drive unit, the fan motor control unit and the sensing unit are disposed on the circuit board, and the circuit board is disposed within the brushless fan motor.

In an embodiment, the power supply unit is further connected to a hot plugging unit.

In an embodiment, one of the power supply unit and the hot plugging circuit is further connected to an electromagnetic interference (EMI) filter circuit.

In an embodiment, one of the power supply unit and the fan motor control unit is further connected to a power output modulation unit.

In an embodiment, the power output modulation unit has an input signal being a pulse width modulation (PWM) control signal.

In an embodiment, the power output modulation unit is a temperature-controlled element or a temperature-controlled circuit.

In an embodiment, the fan motor control unit is further connected to a FG pulse output signal or a RD rotation detection output signal.

In an embodiment, the power supply unit is a switch circuit driven by a PWM signal for modulating a fan motor output power.

### BRIEF DESCRIPTIONS OF THE DRAWINGS

The present invention will be better understood from the following detailed descriptions of the preferred embodiments according to the present invention, taken in conjunction with the accompanying drawings, in which:

FIG. 1 is a schematic diagram of a basic architecture according to the present invention.

FIG. 2 is a schematic block diagram according to the present invention.

FIG. 3 is a schematic diagram of a circuit according to the present invention.

power supply unit 1
fan motor drive unit 2
fan motor control unit 4
sensing unit 5
power output modulation unit 6
circuit board 7
hot plugging unit 8
brushless fan motor A

### DESCRIPTION OF THE PREFERRED EMBODIMENTS

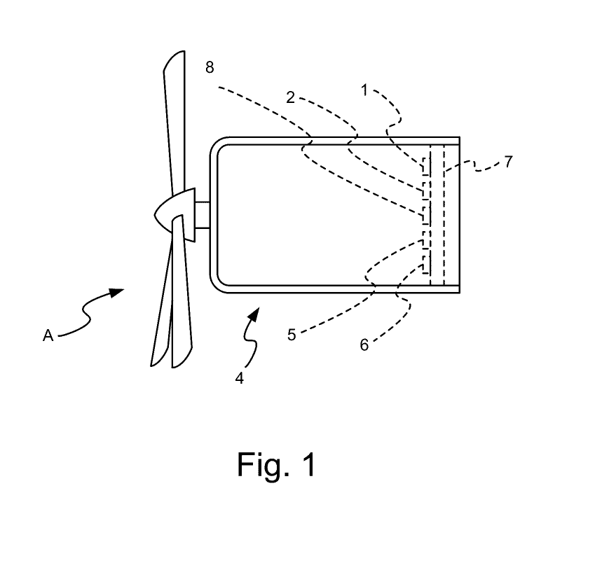

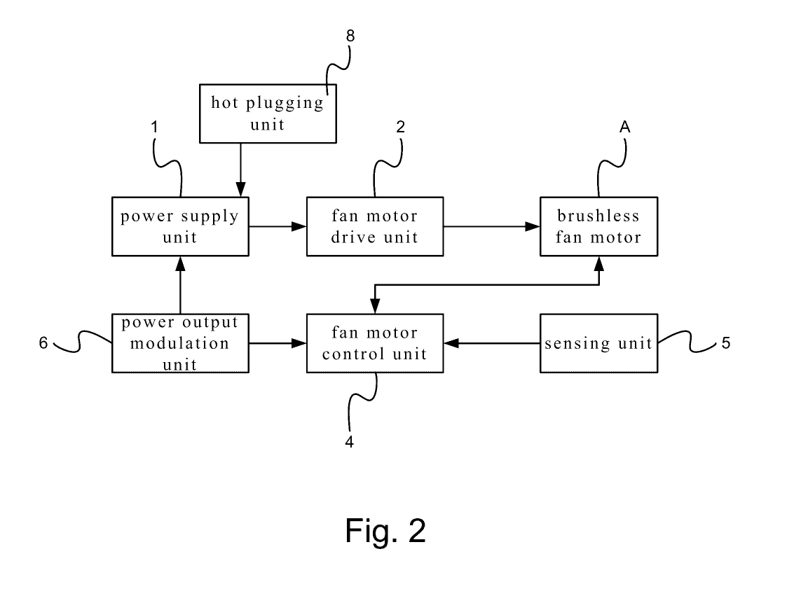

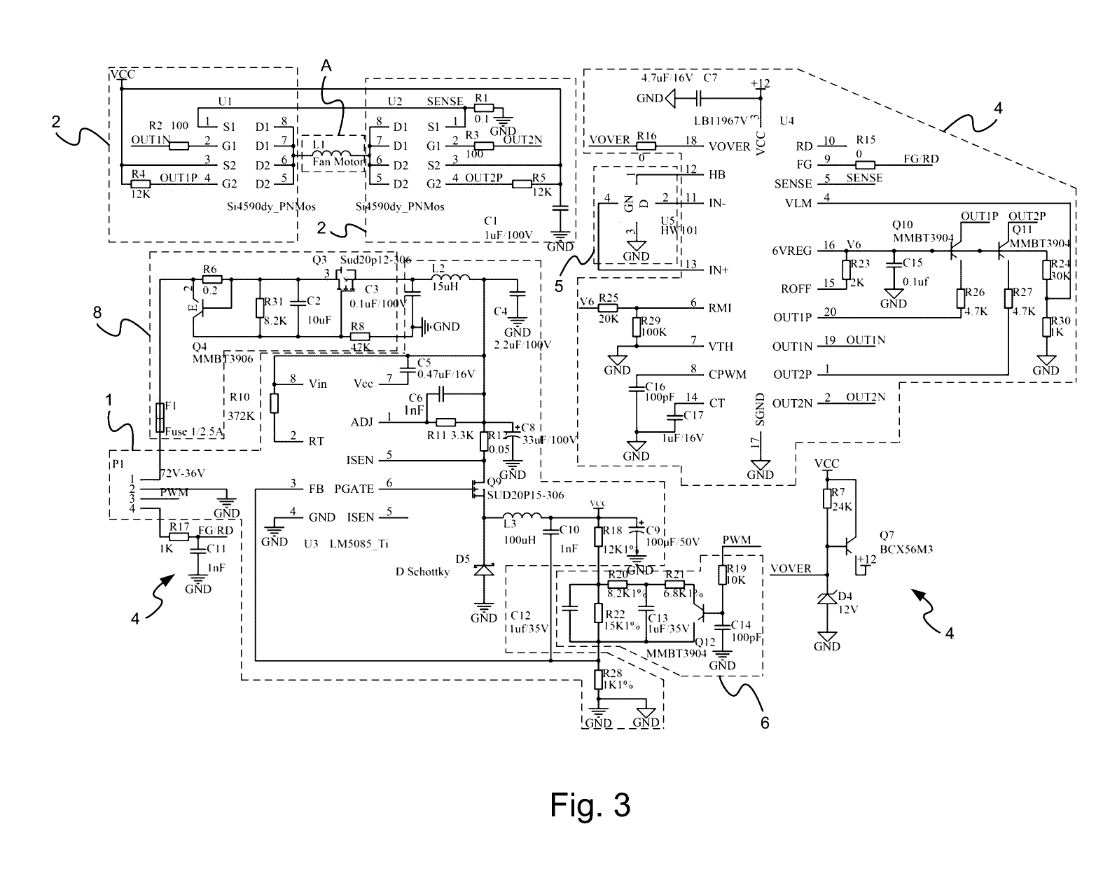

Referring to FIG. 1, FIG. 2, and FIG. 3 are a schematic diagram of a basic architecture according to the present invention, a schematic block diagram according to the present invention, FIG. 3 is a schematic diagram of a circuit according to the present invention, respectively.

As shown, the present invention is a direct current (DC) constant-speed fan motor having a wide input voltage, which comprises a power supply unit 1, a fan motor drive unit 2, a fan motor control unit 4, a sensing unit 5, and a power output modulation unit 6, which are all disposed on a circuit board 7. And, the circuit board 7 is disposed within the brushless fan motor A.

The power supply unit 1 includes an electromagnetic interference (EMI) filter circuit, which is used for filtering some conductive EMI. Further, the power supply unit 1 is a wide voltage input. In addition, the power supply unit 1 is further connected to a hot plugging unit 8.

The fan motor drive unit 2 is connected to the power supply unit 1.

The brushless fan motor A is connected to the fan motor drive unit 2.

The fan motor control unit 4 is connected to the fan motor drive unit 2. The fan motor control unit 4 is further connected to a frequency generation (FG) signal or a RD rotation detection output signal.

The sensing unit 5 is connected to the fan motor control unit 4, while the sensing unit 6 is a Hall device.

The power output modulation unit 6 is connected to the power supply unit 1 or the fan motor control unit 4. The power output modulation unit 6 has an input signal, which is a pulse width modulation (PWM) control signal. And, the power output modulation unit 6 may be a temperature-controlled device or a temperature-controlled circuit. In addition, the power supply unit 1 may be a switch circuit, and driven by a PWM signal to adjust a fan motor output power. That is, after the voltage at a power source end is sampled, the sampled voltage is used with the input signal PWM to obtain a rotational speed of the motor A, detected by operating a switch or using a FG signal. Then, the width of the input PWM signal is changed to perform a switch action.

As such, a novel DC constant-speed brushless fan motor having a wide voltage input is thus completed with the above described structure.

In the beginning of implementing the present invention, an external DC power is inputted by a power supply unit 1, in which an EMI filter circuit is used to filter out some conductive EMI, so that effects brought by the motor itself or any external sources may be prevented. Furthermore, the hot plugging unit 8 may be used to provide the motor to allow a hot-pluggable peripheral device to be inserted or removed when the motor has an external hardware to be inserted or removed, without resulting in the external hardware or the peripheral device being burned out and the motor may be online detected by the external system. Then, the power supply unit 1 is used together with the power output modulation unit 6 to adjust the input voltage to be a power required for the fan motor. At this time, the fan motor has an increased V-I relationship curve, so that the power supply unit 1 outputs a constant current, a constant voltage or a constant power to the fan motor drive unit 2, thereby driving the brushless fan motor A. When the brushless fan motor A is operated, the sensing unit 5 is relied upon to detect an operational state of the brushless fan motor A, so that the fan motor control unit 4 may be online employed to perform an NS magnetic polarity reversal process. Further, a polarity change wave H/L-leveled FG signal is outputted, or a RD level change signal is outputted when no any H/L level change is presented within a specific period time.

In the case that the power output modulation unit 6 is inputted with a PWM signal, the power supply unit 1 is a constant voltage, the PWM is converted to a voltage level and the power supply unit 1 adjusts the output voltage by using a sampling resistor which may be used to sample a voltage. In the case of temperature control, the sampling resistor is replaced with a temperature-controlled device or a temperature-controlled sampling circuit. In this manner, a wide input voltage may be converted into an appropriate power and outputted to the brushless fan motor A, so that the fan motor drive unit 2 may be used to control the brushless fan motor A to reach a full-period driven state. Therefore, the brushless fan motor A may reach a target rotational speed, and which may not be changed with the input voltage, with the efficacies of saved consumed energy and elimination of operation noise achieved simultaneously.

In addition, the power supply unit 1 may be monitored and even compensated by using a MCU through a FG square waved signal, since the motor A may have a dead-locked possibility. Otherwise, inside the power supply unit 1 having a constant current or a constant power has to be compensated with an over voltage and over power protection for the situation where the motor A is likely to be locked dead.

The present invention may not only prevent the rotational speed from being changed, but also the counter EMF will be absorbed by the capacitor of the power supply unit when the power is off, without requiring any additional protective device associated with the fan motor. The power output adjustment unit changes the output power from the fan motor drive unit. Generally, the fan motor's voltage vs. current relationship presents an direct proportion.

If the power supply unit 1 is a constant voltage device, and the full speed is 48V, then the output may be modulated to 47V, 46V, and so forth. Or, if the power supply unit 1 is a constant current device, and the full speed is 2 A, then the output may be modulated to 1.5 A, 1 A, and so forth. Or, if the power supply unit 1 is a constant current device, and the full speed is 2 A, then the output power may be modulated to 40 W, 35 W, 30 W, and so forth, so that the fan motor may be full-period driven, i.e. the fan motor is always 100% PWM driven. This novel drive fashion may prevent the issue of poor low-to-middle rotational speed. For the general fan motors, the rotational speed is several thousand rotations per minute (RPM), which could be not a high frequency, an EMC issue occurring when the PWM is constant-frequency switched and a switch loss of a MOSFET or a transistor.

In view of the above, the inventive DC constant-speed brushless fan motor may effectively overcome some issues encountered in the prior art, where the power supply unit may be used to accept a wide voltage input and convert the wide voltage input into an appropriate output power, so that the appropriate output power may be outputted to the brushless fan motor through the fan motor control unit and the fan motor drive unit. As such, the fan motor may reach a target rotational speed which may not be changed with the input voltage, with the efficacies of saved consumed energy and elimination of operation noise achieved simultaneously.

From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

1. A direct current (DC) constant-speed brushless fan motor having a wide voltage input, comprising:
a DC-DC power supply unit;
a fan motor drive unit, connected to the power supply unit and wherein the power supply unit outputs a constant current, a constant voltage, or a constant power to the fan motor drive unit;
a fan motor, connected to the fan motor drive unit;
a fan motor control unit, connected to the fan motor drive unit;
a sensing unit, connected to the fan motor control unit,
a power output modulation unit, and
a hot plugging unit.

2. The DC constant-speed brushless fan motor having the wide voltage input as claimed in claim 1, wherein the power supply unit, the fan motor drive unit, the fan motor control unit, the sensing unit, the power output modulation unit, and the hot plugging unit are disposed on a circuit board, and the circuit board is disposed within the brushless fan motor.

3. (canceled)

4. The DC constant-speed brushless fan motor having the wide voltage input as claimed in claim 1, wherein one of the power supply unit and the hot plugging circuit is further connected to an electromagnetic interference (EMI) filter circuit.

5. The DC constant-speed brushless fan motor having the wide voltage input as claimed in claim 1, wherein one of the power supply unit and the fan motor control unit is further connected to the power output modulation unit.

6. The DC constant-speed brushless fan motor having the wide voltage input as claimed in claim 5, wherein the power output modulation unit has an input signal being a pulse width modulation (PWM) control signal.

7. The DC constant-speed brushless fan motor having the wide voltage input as claimed in claim 5, wherein the power output modulation unit is a temperature-controlled element or a temperature-controlled circuit.

8. The DC constant-speed brushless fan motor having the wide voltage input as claimed in claim 1, wherein the fan motor control unit is further connected to a frequency generation (FG) signal or a rotation detection (RD) output signal.

9. The DC constant-speed brushless fan motor having the wide voltage input as claimed in claim 1, wherein the power supply unit is a switch circuit driven by a PWM signal for modulating a fan motor output power.
